(19) United States
(12) Patent Application Publication
(10) Pub. No.: US 2026/0275898 A1
(43) Pub. Date: Sep. 17, 2026

(54) INTEGRATED CONTROL APPARATUS FOR VEHICLE COOLING FLUID MODULE AND CONTROL METHOD THEREOF

(71) Applicant: Hanon Systems, Daejeon (KR)

(72) Inventors: Ho Beom KIM, Daejeon (KR); Yi Eung KIM, Daejeon (KR); Ho Youn KIM, Daejeon (KR); Jun Ho KANG, Daejeon (KR); Jae Woo KONG, Daejeon (KR); Doo-Soo PARK, Daejeon (KR); Kyung Won AN, Daejeon (KR); Tae Ho OH, Daejeon (KR); Jae Won LEE, Daejeon (KR); Tae Hyeong KIM, Daejeon (KR)

(73) Assignee: Hanon Systems, Daejeon (KR)

(21) Appl. No.: 19/566,058

(22) Filed: Mar. 13, 2026

(30) Foreign Application Priority Data
Mar. 14, 2025 (KR) 10-2025-0033336
Feb. 6, 2026 (KR) 10-2026-0024343

(51) Int. Cl. F01P 5/12; B60H 1/32; F01P 7/14; F01P 11/14

(52) U.S. Cl. CPC F01P 5/12; B60H 1/3205; F01P 7/14; F01P 11/14; F01P 2007/146

(57) ABSTRACT

The present disclosure relates to an integrated control apparatus for a vehicle cooling fluid module, which controls a flow of a cooling fluid through an air conditioning system, electrical components, or engine for a vehicle, and more specifically, to an integrated control apparatus for a vehicle cooling fluid module, which comprehensively control a plurality of pumps or valves using a single control unit, and a control method thereof.

### CROSS REFERENCE TO RELATED APPLICATION

The present application claims priority to Korean Patent Application No. 10-2025-0033336, filed on Mar. 14, 2025, and Korean Patent Application No. 10-2026-0024343, filed on Feb. 06, 2026, the entire contents of which are incorporated herein for all purposes by this reference.

### BACKGROUND OF THE DISCLOSURE

### Field of the Disclosure

The present disclosure relates to an integrated control apparatus for a vehicle cooling fluid module, which controls a flow of a cooling fluid through an air conditioning system, electrical components, or engine for a vehicle, and more specifically, to an integrated control apparatus for a vehicle cooling fluid module, which comprehensively control a plurality of pumps or valves using a single control unit, and a control method thereof.

### Description of the Related Art

A vehicle has coolant channels formed to cool an engine, a transmission, electrical components, or a battery, a refrigerant channel is also formed to circulate heat in an air conditioning system, and a change in the coolant channel by a thermostat is also essentially required for rapid warm-up of the engine or the battery under a low-temperature condition.

The coolant channel formed to manage a temperature of the engine and the transmission are typically coupled to valves, which are controlled by an external controller to ensure temperature control. A coolant pump is also connected to and controlled by a controller, and coolant channel valves and the controller connected to the coolant pump are typically connected integrally within a housing, or are separately connected to an outer side of the housing by wires.

FIG. 1 is a block diagram illustrating a conventional cooling fluid module control system. As illustrated, the conventional cooling fluid module control system includes a control module 10, a coolant module 20, and a refrigerant module 30, and the control module 10 includes a main controller 11. The main controller 11 transmits control signals for controlling the coolant module 20 and the refrigerant module 30 to individual controllers 21 and 31 provided in the electrical components of the coolant module 20 and the refrigerant module 30, respectively, and the individual controllers 21 and 31 transmit individual control signals for controlling the electrical components of the coolant module 20 and the refrigerant module 30 to the connected electrical components, respectively, based on the control signals. That is, in the conventional control system, a plurality of individual controllers 21 and 31 are integrally provided with respective electrical components to control the electrical components (e.g., an electric water pump (EWP), a multi V/V for coolant, a 3-way valve, and an electronic expansion valve (EXV)) of the coolant module 20 and the refrigerant module 30.

Meanwhile, the valve determines a displacement (position) of the valve through a Hall sensor IC, and since the Hall sensor is configured such that a position value of a fixed range is repeated, it can determine only a change in the movement of the valve, and thus an initial value needs to be set. Accordingly, when a position of the initial value of the valve is changed by an external force or an event situation (constraint, semi-constraint) during operation, the initial value needs to be calibrated.

In this case, in the case of the conventional individual control method using the respective controllers 21 and 31, the control system cannot detect the replacement of a single component because the controller is replaced when a single component is replaced, and thus the initial value needs to be calibrated each time the vehicle’s power is reset in consideration of the case in which the single component is replaced. Accordingly, the repeated calibration of the initial value each time the vehicle’s power is reset shortens the valve’s lifetime.

In addition, when the process of calibrating the initial value is repeatedly performed under heat generation conditions of the valve caused by continuous vehicle operation, a problem may occur in that thermal durability is degraded.

### SUMMARY OF THE DISCLOSURE

The present disclosure is directed to providing an integrated control apparatus for a vehicle cooling fluid module in which a single controller for comprehensively controlling each valve is separately configured outside a valve, and a control method thereof.

The present disclosure is also directed to providing an integrated control apparatus for a vehicle cooling fluid module, which may detect the replacement of a single valve by comparing a product ID of a single controller provided outside the valve when the valve is replaced, and a control method thereof.

Accordingly, the present disclosure is directed to providing an integrated control apparatus for a vehicle cooling fluid module, which determines whether initial value calibration is required, such as when a single component is replaced or an event occurs, even in a vehicle power reset situation, and performs calibration only when the initial value calibration is required, and a control method thereof.

According to one embodiment of the present disclosure, there is provided an integrated control apparatus for controlling a cooling fluid module including one or more components for controlling a cooling fluid for a vehicle, which includes a drive module which is connected to each of components and drives the components, and an integrated controller configured to transmit a control signal to control the components to the drive module, wherein the integrated controller is a single controller configured to control the components and is configured separately from the cooling fluid module.

The integrated controller determines whether the component has been replaced upon a power reset and performs initial value calibration on the component.

The integrated controller stores a product ID of the component by being communicatively connected to the component and performs the initial value calibration on the component by comparing the pre-stored product ID of the component with a product ID of the component communicated after a reset.

The integrated controller may identify a component having a product ID different from the pre-stored product ID and may perform the initial value calibration on the identified component.

The one or more components include a pump or a valve.

The pump is an electric water pump configured to control coolant for cooling an engine, a battery, or vehicle electrical components.

The valve is at least one selected from a 3-way valve for controlling refrigerant for heat exchange in an air conditioning system, an electronic expansion valve (EXV), or a multi-valve (Multi V/V) for controlling coolant for cooling the engine, the battery, or the vehicle electrical components.

The integrated controller is connected to the component via single edge nibble transmission_short PWM code (SENT/SPC) communication.

The drive module serially connected to the integrated controller and may receive the control signal for controlling the component from the integrated controller.

The cooling fluid module includes a refrigerant module and a coolant module, wherein the drive module is connected to components included in the refrigerant module and components included in the coolant module, respectively, and wherein the integrated controller generates control signals for controlling the components included in the refrigerant module and the components included in the coolant module and transmits the control signals to the respective drive modules.

The cooling fluid module includes a refrigerant module, wherein the drive module is connected to components included in the refrigerant module, respectively, and wherein the integrated controller generates control signals for controlling the components included in the refrigerant module and transmits the control signals to the respective drive modules.

The integrated controller performs the initial value calibration regardless of whether the component has been replaced when at least one event occurs, the event including failure to reach a target position of the component, short circuit, open circuit, binding, overtemperature, or position sensor error.

According to an embodiment of the present disclosure, there is provided a control method using the integrated control apparatus according to an embodiment of the present disclosure, which includes determining, by an integrated controller, whether one or more components are replaced upon a power reset, and performing, by the integrated controller, initial value calibration on a component when it is determined that the component has been replaced.

The determining, by the integrated controller, whether one or more components are replaced upon a reset includes storing, by the integrated controller communicatively connected to the component, a product ID of the component, comparing the previously stored product ID of the component upon a power reset with a product ID of the component communicated after the reset, and determining that the component has been replaced when the compared product IDs are different.

The performing, by the integrated controller, the initial value calibration on the component when it is determined that the component has been replaced further includes identifying the component having a different product ID from the compared product ID and performing the initial value calibration on the identified component.

### BRIEF DESCRIPTION OF THE DRAWINGS

FIG. 1 is a block diagram illustrating a conventional cooling fluid module control system.

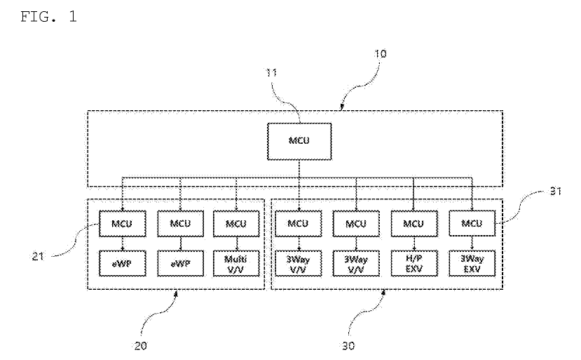

FIG. 2 is a perspective illustrating an integrated control apparatus according to an embodiment of the present disclosure.

FIG. 3 is a block diagram illustrating an integrated control apparatus according to the embodiment of the present disclosure.

FIG. 4 is a flowchart illustrating an integrated control method using the integrated control apparatus according to the embodiment of the present disclosure.

FIG. 5 is a block diagram illustrating an integrated control apparatus according to another embodiment of the present disclosure.

### DETAILED DESCRIPTION OF THE DISCLOSURE

Hereinafter, an embodiment of the present disclosure will be described in detail with reference to the drawings.

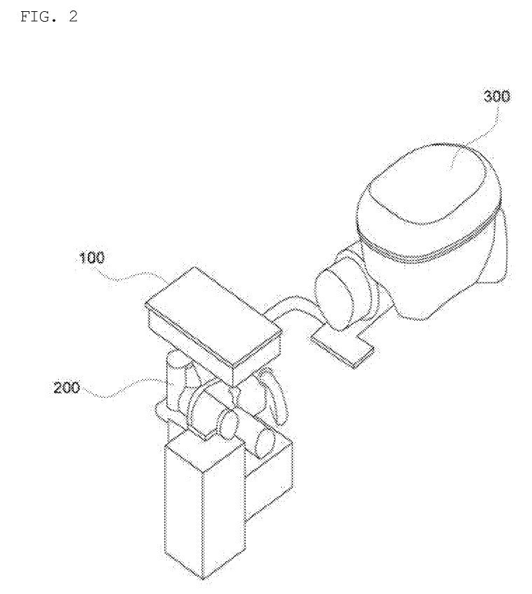

FIG. 2 is a perspective view of an integrated control apparatus 1000 according to the embodiment of the present disclosure. Referring to FIG. 2, the integrated control apparatus 1000 according to the embodiment of the present disclosure includes an integrated control unit 100, a refrigerant module 200, and a coolant module 300.

The integrated control unit 100 may be coupled to the refrigerant module 200 and connected to an external power source, the refrigerant module 200, and the coolant module 300. Here, the external power source may be a vehicle battery.

The integrated control unit 100 may be coupled to the refrigerant module 200 and coupled to an upper end of the refrigerant module 200 to facilitate easy attachment and detachment. In addition, the integrated control unit 100 is electrically connected to the external power source, the refrigerant module 200, and the coolant module 300 to control the refrigerant module 200 and the coolant module 300. The integrated control unit 100 may include respective connectors for electrical connection to the external power source, the refrigerant module 200, and a coolant module 300.

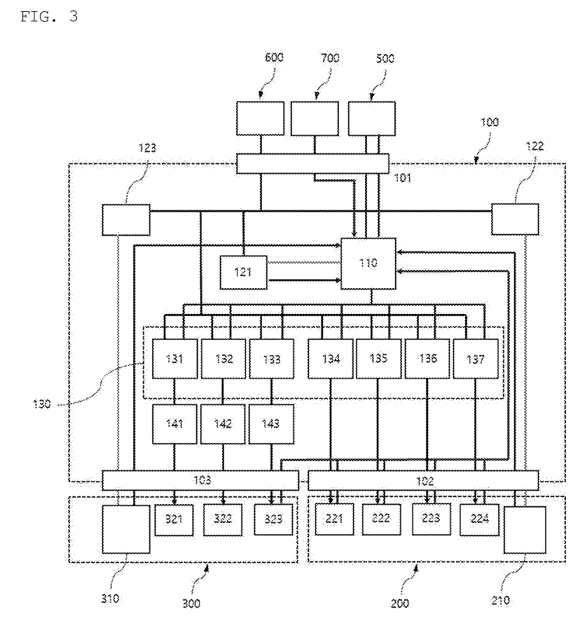

FIG. 3 illustrates a block diagram of the integrated control apparatus 1000 according to the embodiment of the present disclosure.

Referring to FIG. 3, the integrated control apparatus 1000 according to an embodiment of the present disclosure includes an integrated control unit 100, a refrigerant module 200, and a coolant module 300. The integrated control unit 100 includes an integrated controller 110, power circuits 121, 122, and 123, a drive module 130, and components whose operation is controlled by the drive module 130.

Hereinafter, in the present specification, the term “component” collectively refers to all active driving elements disposed in the refrigerant module 200 or the coolant module 300 for regulating a flow, a flow rate, or a pressure of a fluid according to control signals from the integrated controller 110. As a specific example, the component may refer to one or more pumps and/or valves, and depending on the configuration of the system, may be interpreted to include elements such as a multi-valve (Multi V/V), a three-way valve (3-way valve), an electronic expansion valve (EXV), a directional switching valve, and an electric water pump (EWP).

Further, throughout the detailed description and the claims of the present specification, the terms “component” and “pump” or “valve” may be used interchangeably unless otherwise specified. Accordingly, a configuration described as a “pump” or a “valve” in a particular embodiment should be understood as a subordinate concept corresponding to the “component” recited in the claims.

The integrated control unit 100 is connected to a higher-level controller 500, a power supplier 600, and a starter 700 via a power connector 101. The higher-level controller 500 transmits high-level control signals to the integrated controller 110, and the power supplier 600 is connected to the first to third power circuits 121, 122, and 123 in parallel to supply electric power. In addition, the starter 700 transmits a drive signal to the integrated controller 110. That is, the integrated controller 110 is driven by the starter 700, and specifically, when power supply is interrupted and then restored, a reset signal is transmitted to the integrated controller 110 to restart the integrated control apparatus 1000.

The integrated controller 110 may transmit control signals for controlling a plurality of pumps or valves included in the refrigerant module 200 and the coolant module 300 to each of a plurality of drive modules 130. The refrigerant module 200 may include, for example, 3-way valves 221, 222, and 223, an electronic expansion valve (EXV) 224, etc., and the coolant module 300 may include electric water pumps (EWPs) 321 and 322, a multi valve (multi V/V) 323 for coolant, etc.

According to the present disclosure, the integrated controller 110 for controlling the pumps 321 and 322 or the valves 323, 221, 222, 223, and 224 is separately configured in the integrated control unit 100 from the refrigerant module 200 or the coolant module 300. In addition, according to the present disclosure, each of the plurality of pumps or valves is controlled by a single integrated controller 110.

Specifically, the integrated controller 110 may receive a higher-level control command from the higher-level controller 500 for a vehicle and transmits a control signal to each of the plurality of drive modules 130 based on the higher-level control command. Here, the higher-level controller 500 may be, for example, a vehicle platform controller (VPC).

In particular, the integrated controller 110 may be directly connected to each pump or valve for communication and may acquire a product ID from each pump or valve. The integrated controller 110 may be connected to each pump or valve via, for example, single edge nibble transmission_short PWM code (SENT/SPC) communication. Based on the product ID of the pump or valve stored through the above process, the integrated controller 110 may transmit a control signal to one or more of the drive modules 131 to 137 assigned the product ID of the pump or valve requiring control. Accordingly, the integrated controller 110 may determine, based on the higher-level control command received from the higher-level controller 500, which pump or valve among the pumps or valves of the refrigerant module 200 and the coolant module 300 needs to receive the control signal. Once the integrated controller 110 identifies the pump or valve to which the control signal will be transmitted, it may transmit the control signal to the drive modules 131 to 137 connected to the pump or valve.

Meanwhile, the integrated controller 110 is configured to determine the replacement of a single component by comparing the product ID of the previously stored pump or valve with the product ID of the currently communicating pump or valve when receiving a power reset signal through the starter 700. That is, when the existing product ID and the current product ID are the same, it may be determined that the pump or valve has not been replaced, and when they are not the same, it may be determined that the pump or valve has been replaced.

Accordingly, initial value calibration for each pump or valve is not performed each time the power of the vehicle, which is a subject of the integrated control apparatus 1000, is reset by the integrated controller 110, and the initial value calibration may be performed only when it is necessarily required, such as when a single component is replaced or an event occurs.

The event refers to a check item related to its own safety (Fail-Safety) of the integrated controller 110 and may include, for example, failure to reach a target position of the pump or valve, short circuit/open circuit, binding, overtemperature, initialization failure, position sensor error, etc.

Furthermore, by performing the initial value calibration only for pumps or valves determined to have been replaced, unnecessary initial value calibration for pumps or valves that have not been replaced can be limited.

A first power circuit 121 supplies electric power from the power supplier 600 to the integrated controller 110, a second power circuit 122 supplies electric power to the refrigerant module 200 via a refrigerant module connector 102, and a third power circuit 123 supplies electric power to the coolant module 300 via a coolant module connector 103.

The drive module 130 is configured as a plurality of drive modules to drive each of the plurality of pumps or valves included in the refrigerant module 200 and the coolant module 300, and the plurality of drive modules 131 to 137 are connected to the power supplier 600 via the power connector 101 to receive electric power and connected to the integrated controller 110 to receive control signals. Each of the drive modules 131 to 137 is serially connected to the integrated controller 110 and may directly receive a control signal for controlling operation of a pump or a valve assigned to the respective drive module 131 to 137.

The drive modules 130 may be connected to the pumps or valves of the refrigerant module 200 and the coolant module 300, respectively. The refrigerant module 200 may include, for example, the 3-way valves 221, 222, and 223, the EXV 224, etc., and the coolant module 300 may include the EWPs 321 and 322, the multi V/V 323 for coolant, etc.

The plurality of drive modules 131 to 137 are a plurality of driver ICs corresponding one-to-one to the pumps or valves, and may supply electric power to the pump or valve and at the same time, operate the pump or valve based on the control signal received from the integrated controller 110.

In addition, the drive modules 131 to 137 may be a code-free driver ICs, for example, application-specific integrated circuit (ASIC) logic ICs that do not require separate software code. That is, the drive module 130 may control the pump or valve based on the control signal received from the integrated controller 110 without generating a separate control signal to control the pump or valve.

In addition, each of the drive modules 131, 132, and 133 connected to the EWPs 321, 322, and 323 or the multi V/V 323 for coolant provided in the coolant module 300 among the drive modules 130 may be connected to one or more metal-oxide-semiconductor field-effect transistors (MOSFETs) 141, 142, and 143. That is, the drive module 131, 132, and 133 connected to the EWP 321 and 322 consuming high power and the multi V/V 323 for coolant may provide electric power appropriate for each pump or valve as well as the MOSFETs 141, 142, and 143.

In addition, the drive module 130 may include step motor driver ICs 134, 135, 136, and 137 connected to the 3-way valves 221, 222, and 223 and the EXV 224 of the refrigerant module 200 and include field oriented control (FOC) ICs 131 and 132 connected to the EWPs 321 and 322 of the coolant module 300, and a gate driver 133 connected to the multi V/V 323 for coolant.

Meanwhile, the integrated control apparatus 1000 further includes a first sensor 210 for sensing surrounding environmental information of the valves of the refrigerant module 200 and a second sensor 310 for sensing surrounding environmental information of the pumps or valves of the coolant module 200.

The surrounding environment information may include at least one of barometric pressure information, temperature information, and coolant level information. Accordingly, the first sensor 210 may be a pressure sensor for sensing the barometric pressure information or a temperature sensor for sensing the temperature information, and the second sensor 310 may be a level sensor for sensing the coolant level information.

The integrated controller 110 may transmit control signals to each of the plurality of drive modules 130 based on the surrounding environment information received from the first sensor 210 and the second sensor 310. Specifically, the integrated controller 110 may determine the pump or valve of the refrigerant module 200 and the coolant module 300 to which the control signal will be transmitted based on the surrounding environment information received from the first and second sensors 210 and 310. Once the integrated controller 110 identifies the pump or valve to which the control signal will be transmitted, it may transmit the control signal to the drive module connected to the corresponding pump or valve. In this case, the integrated controller 110 may transmit the control signal to the drive module 130 assigned the product ID of the pump or valve requiring control based on the product ID of the previously stored pump or valve.

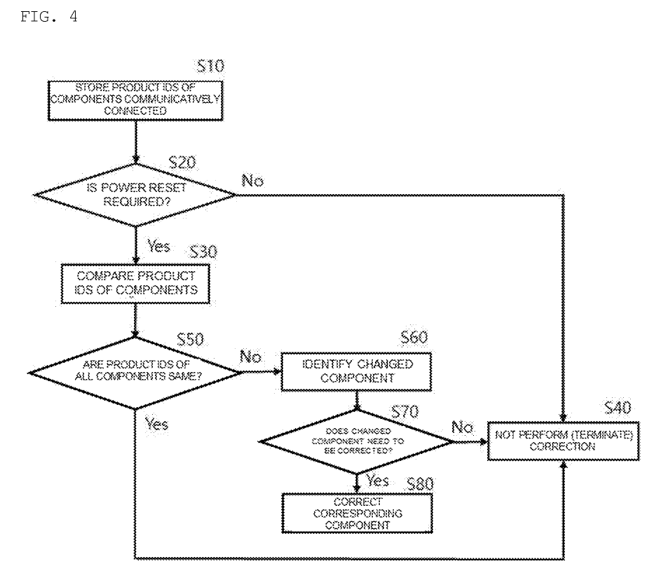

FIG. 4 illustrates a flowchart of an integrated control method using the integrated control apparatus according to the embodiment of the present disclosure, specifically, a method of determining whether initial value calibration is performed.

First, operation S10 of storing the product ID of each pump or valve in the integrated controller 110 that is communicatively connected to each of the plurality of pumps or valves provided in the refrigerant module 200 and the coolant module 300 is performed.

Subsequently, operation S20 of determining whether a power reset of the integrated control apparatus is required, such as replacement of one or more of the pumps or valves or a vehicle power reset, is performed.

Subsequently, when a reset is required, operation S30 of comparing the product IDs of the pumps or valves after the reset is performed. Specifically, the product ID stored in operation S10 is compared with the product ID of each pump or valve after the reset by the integrated controller 110.

When no event requiring a reset is sensed, the process is terminated without performing the initial value calibration process (S40).

After operation S30, the integrated controller 110 determines whether the product IDs of all individual products are the same as the previously stored product IDs (S50).

When they are the same, the process is terminated without performing the initial value calibration process (S40).

When they are not the same, operation S60 of identifying a pump or a valve whose product ID has been changed is performed.

Subsequently, operation S70 of determining whether the changed pump or valve needs to be corrected is performed. According to the present disclosure, the product ID is determined based on whether electric power is applied to the starter 700, and since most component replacements are performed in a turn-off state, whether a pump or valve has been replaced is determined upon restart, and an initialization process is performed.

When correction is required, operation S80 of performing an initial value calibration operation for the identified pump or valve is performed.

When calibration is not required, the process is terminated without performing the initial value calibration process (S40).

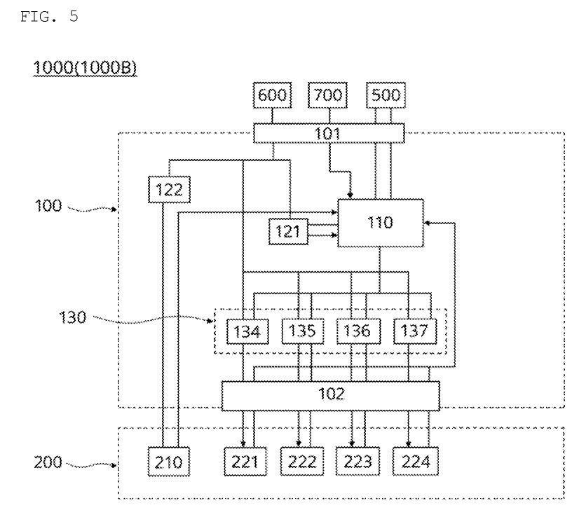

Referring to FIG. 5, a configuration diagram of an integrated control apparatus 1000B according to another embodiment of the present disclosure is illustrated.

Referring to FIG. 5, the integrated control apparatus 1000B according to an embodiment of the present disclosure includes an integrated control unit 100 and a refrigerant module 200, and the integrated control unit 100 may include an integrated controller 110, power circuits 121 and 122, and a drive module 130.

The integrated control unit 100 is connected to a higher-level controller 500, a power supplier 600, and a starter 700 through a power connector 101. The higher-level controller 500 transmits a higher-level control signal to the integrated controller 110, and the power supplier 600 is connected in parallel to the first and second power circuits 121 and 122 to supply electric power.

The power supplier 600 receives external power and converts and supplies the power to a driving voltage suitable for respective driving elements within the integrated control unit 100. Specifically, the power supplier 600 may include an EMC (Electromagnetic Compatibility) filter for suppressing electromagnetic noise introduced from outside, and may further include a DC-link capacitor and a reverse-voltage protection circuit for stable power supply.

Further, the starter 700 transmits a driving signal to the integrated controller 110. That is, the integrated controller 110 is driven through the starter 700, and specifically, when power supply is interrupted and then restored, the starter 700 transmits a reset signal to the integrated controller 110 to restart the integrated control apparatus 1000.

The integrated controller 110 may transmit control signals for controlling a plurality of valves included in the refrigerant module 200 to respective ones of a plurality of drive modules 130. For example, the refrigerant module 200 may include three-way valves 221, 222, and 223 and an electronic expansion valve EXV 224.

Specifically, the integrated controller 110 receives a higher-level control command from the higher-level controller 500 of a vehicle and transmits control signals to the plurality of drive modules 130 based on the higher-level control command. Here, the higher-level controller 500 may be, for example, a VPC (Vehicle Platform Controller).

In particular, the integrated controller 110 may be directly connected to each valve for communication and may acquire a product ID from each valve. For example, the integrated controller 110 may be connected to each valve through SENT/SPC (Single Edge Nibble Transmission / Short PWM Code) communication. Based on the product ID of the valve stored through the above process, the integrated controller 110 may transmit control signals to one or more of the drive modules 134, 135, ..., 137 to which the product ID of the valve requiring control is assigned. Accordingly, the integrated controller 110 may determine, based on the higher-level control command received from the higher-level controller 500, which valve among the valves of the refrigerant module 200 should receive the control signal. Once the integrated controller 110 identifies the valve to which the control signal will be transmitted, the integrated controller 110 may transmit the control signal to the drive module 134, 135, ..., 137 connected to the corresponding valve.

Meanwhile, when receiving a power reset signal through the starter 700, the integrated controller 110 is configured to determine whether a component has been replaced by comparing the previously stored product ID of the valve with the product ID of the valve currently communicating. That is, when the existing product ID and the current product ID are identical, the valve is determined not to have been replaced, and when they are different, the valve is determined to have been replaced.

Accordingly, when the vehicle power, which is the subject of the integrated control apparatus 1000, is reset, the integrated controller 110 does not perform initial value calibration for each valve every time, and may determine whether calibration is necessary and perform initial value calibration only when required, such as when a component is replaced or when an event occurs.

The event refers to check items related to fail-safety of the integrated controller 110, and may include, for example, failure of the valve to reach a target position, short circuit or open circuit, binding, overtemperature, initialization failure, and position sensor error.

Furthermore, since initial value calibration is performed only for valves determined to have been replaced, unnecessary initial value calibration for valves that have not been replaced may be limited.

The first power circuit 121 supplies power from the power supplier 600 to the integrated controller 110, and the second power circuit 122 supplies power to the refrigerant module 200 through the refrigerant module connector 102.

The drive module 130 is provided as a plurality of drive modules for driving respective valves included in the refrigerant module 200, and the plurality of drive modules 134, 135, ..., 137 are connected to the power supplier 600 through the power connector 101 to receive electric power and are connected to the integrated controller 110 to receive control signals.

Each of the drive modules 134, 135, 136, and 137 is serially connected to the integrated controller 110, for example through SPI (Serial Peripheral Interface), and may receive control commands from the integrated controller 110 or transmit status information and diagnostic information. In particular, each drive module may be directly connected to the integrated controller 110 through a dedicated enable/fault EN/FAULT pin, thereby providing an immediate interrupt signal when an abnormal condition occurs in the drive module regardless of an SPI communication cycle. In addition, a status register within each drive module may store specific diagnostic information such as overcurrent, overheating, or short circuit. When receiving the interrupt signal, the integrated controller 110 may read the status register through SPI communication to identify the cause of the fault and perform a corresponding control operation.

The drive module 130 may be connected to valves of the refrigerant module 200, respectively. For example, the refrigerant module 200 may include three-way valves 221, 222, and 223 and an electronic expansion valve EXV 224.

The plurality of drive modules 134, 135, ..., 137 may be driver ICs corresponding one-to-one to the respective valves and may supply electric power to the valves and operate the valves based on control signals received from the integrated controller 110.

Further, each of the drive modules 134, 135, ..., 137 may be a code-free driver IC, for example an ASIC (Application Specific Integrated Circuit) logic IC that does not require separate software code. That is, the drive module 130 may control the valve based on the control signal received from the integrated controller 110 without generating a separate control signal for controlling the valve.

Further, the drive module 130 may include step motor driver ICs 134, 135, 136, and 137 connected to the three-way valves 221, 222, and 223 and the electronic expansion valve EXV 224 of the refrigerant module 200.

According to the present disclosure, a single integrated controller 110 may individually control and monitor the plurality of drive modules 134, 135, 136, and 137 and receive status information and diagnostic information from each drive module. Accordingly, redundancy in hardware and software may be prevented, and power management efficiency may be improved.

Meanwhile, the integrated control apparatus 1000 may further include a first sensor 210 for sensing surrounding environmental information of the valves of the refrigerant module 200.

The surrounding environmental information may include at least one of barometric pressure information, temperature information, and coolant level information. Accordingly, the first sensor 210 may be a pressure sensor for sensing barometric pressure information or a temperature sensor for sensing temperature information.

The integrated controller 110 may transmit control signals to the plurality of drive modules 130 based on surrounding environmental information received from the first sensor 210. Specifically, the integrated controller 110 may determine which valve of the refrigerant module 200 should receive the control signal based on the surrounding environmental information received from the first sensor 210. When the integrated controller 110 identifies the valve to which the control signal will be transmitted, the integrated controller 110 may transmit the control signal to the drive module 130 connected to the corresponding valve. In this case, the integrated controller 110 may transmit the control signal to the drive module 130 assigned the product ID of the valve requiring control based on the previously stored product ID of the valve.

According to the integrated control apparatus for a vehicle cooling fluid module and the control method thereof of the present disclosure having the above configuration, since the initial value calibration can be performed by detecting the replacement of the single valve, the initial value calibration is not required each time the vehicle power is reset, thereby increasing the lifetime of the single valve.

In addition, since the number of initial value calibrations for a non-replaced valve is significantly reduced, the initial value calibration under heat-generation conditions caused by continuous vehicle operation can be suppressed, thereby preventing degradation of thermal durability of the valve.

The technical spirit of the present disclosure should not be construed as limited to the above embodiments. Not only the scope of applications is diverse, but also various modifications may be made by those skilled in the art without departing from the gist of the present disclosure as claimed in the claims. Accordingly, these improvements and changes fall within the scope of the present disclosure as long as they are obvious to those skilled in the art.

### DESCRIPTION OF REFERENCE NUMERALS

1000: integrated control apparatus

100: integrated control unit

101, 102, 103: connectors

110: integrated controller

121, 122, 123: power circuits

130: drive module

141, 142, 143: FETs

200: refrigerant module

210: first sensor

221, 222, 223, 224: refrigerant module valves

300: coolant module

310: second sensor

321, 322: coolant pumps

323: coolant valve

500: higher-level controller

600: power supplier

700: starter

What is claimed is:

1. An integrated control apparatus for controlling a cooling fluid module including one or more components for controlling a cooling fluid for a vehicle, the integrated control apparatus comprising:
a drive module which is connected to each of components and drives the components; and
an integrated controller configured to transmit a control signal to control the components to the drive module,
wherein the integrated controller is a single controller configured to control the components and is configured separately from the cooling fluid module.

2. The integrated control apparatus of claim 1, wherein the integrated controller determines whether the component has been replaced upon a power reset and performs initial value calibration on the component.

3. The integrated control apparatus of claim 2, wherein the integrated controller is configured to:
store a product ID of the component by being communicatively connected to the component; and
perform the initial value calibration on the component by comparing the pre-stored product ID of the component with a product ID of the component communicated after a reset.

4. The integrated control apparatus of claim 3, wherein the integrated controller is configured to perform the initial value calibration by comparing the pre-stored product ID of the component with the product ID of the component communicated after the reset to identify a component different from the product ID.

5. The integrated control apparatus of claim 1, wherein the one or more components include a pump or a valve.

6. The integrated control apparatus of claim 5, wherein the pump is an electric water pump configured to control coolant for cooling an engine, a battery, or vehicle electrical components.

7. The integrated control apparatus of claim 5, wherein the valve is at least one selected from a 3-way valve for controlling refrigerant for heat exchange in an air conditioning system, an electronic expansion valve (EXV), or a multi-valve (Multi V/V) for controlling coolant for cooling the engine, the battery, or the vehicle electrical components.

8. The integrated control apparatus of claim 3, wherein the integrated controller is connected to the component via single edge nibble transmission_short PWM code (SENT/SPC) communication.

9. The integrated control apparatus of claim 1, wherein the drive module is serially connected to the integrated controller and receives, from the integrated controller, the control signal for controlling the component.

10. The integrated control apparatus of claim 1, wherein the cooling fluid module includes a refrigerant module and a coolant module,
wherein the drive module is connected to components included in the refrigerant module and components included in the coolant module, respectively, and
wherein the integrated controller generates control signals for controlling the components included in the refrigerant module and the components included in the coolant module and transmits the control signals to the respective drive modules.

11. The integrated control apparatus of claim 1, wherein the cooling fluid module includes a refrigerant module,
wherein the drive module is connected to components included in the refrigerant module, respectively, and
wherein the integrated controller generates control signals for controlling the components included in the refrigerant module and transmits the control signals to the respective drive modules.

12. The integrated control apparatus of claim 2, wherein the integrated controller performs the initial value calibration regardless of whether the component has been replaced when at least one event occurs, the event including failure to reach a target position of the component, short circuit, open circuit, binding, overtemperature, or position sensor error.

13. A control method using the integrated control apparatus of claim 1, the control method comprising:
determining, by an integrated controller, whether one or more components are replaced upon a power reset; and
performing, by the integrated controller, initial value calibration on a component when it is determined that the component has been replaced.

14. The control method of claim 13, wherein the determining, by the integrated controller, whether one or more components are replaced upon a reset includes:
storing, by the integrated controller communicatively connected to the component, a product ID of the component;
comparing the previously stored product ID of the component upon a power reset with a product ID of the component communicated after the reset; and
determining that the component has been replaced when the compared product IDs are different.

15. The control method of claim 14, wherein the performing, by the integrated controller, the initial value calibration on the component when it is determined that the component has been replaced further includes identifying the component having a different product ID from the compared product ID and performing the initial value calibration on the identified component.
